(19) United States
(12) Patent Application Publication
(10) Pub. No.: US 2010/0225128 A1
(43) Pub. Date: Sep. 9, 2010

(54) Actuating Handle for a Door

(76) Inventors: Heinz-Eckhard Engel, Glurns (IT); Rudolf Stieger, Laas (IT); Elias Karnutsch, Nauders (AT); Christian Josef Stephan Zeus, Stilfs (IT)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 12/667,493

(22) PCT Filed: Jun. 20, 2008
(86) PCT No.: PCT/EP08/05000

§ 371 Date: May 20, 2010

(30) Foreign Application Priority Data
Jul. 2, 2007 (DE) 10 2007 030 655.7

(51) Int. Cl. E05B 3/00; F16C 19/00

(52) U.S. Cl. 292/336.3; 384/50

(57) ABSTRACT

The invention relates to an actuating handle with a stop element for a door. The stop element comprises at least one attachment element that can be fixed to the door, a handle for actuating the door and/or a closure device arranged in the door. The attachment element, which is arranged and/or designed in such a way that it can be fixed at and/or in the closure device perpendicularly to the longitudinal axis of the stop element is connected with the stop element and can be introduced into the closure device by passing through a lateral surface of the door. In this way, the mounting of the actuating handle is made easier and can be carried out independently of the respective installation situation, if possible without tools.

### SUMMARY OF THE INVENTION

For an actuating handle for a door, with a stop element, which is mounted to the door with at least one mounting member, and with a handle to operate the door and/or to operate a lock contained within the door, the invention proposes to link the mounting member with the stop element and to insert it into the lock through a side surface of the door, where the mounting member is placed and/or embodied such that it can be affixed parallel to the longitudinal axis of the stop element on and/or in the lock.

This arrangement, which is as simple as it is unusual, does no longer affix the stop element of the actuating handle by means of cams and screws on the door leaf, as has been the state of the art; rather, the stop element is mounted in or with the assistance of the lock, which is generally pre-mounted by the manufacturer anyway. The mounting members of the stop elements are affixed preferably closely and solidly, thus mounting the system in a direction that is perpendicular to the longitudinal axis of the stop element and thus radially and also solidly within the plane of the door leaf. Cams or screws are no longer required to mount the fitting. As a result, there is also no longer a need to drill holes by hand in the door leaf to mount the fitting. The recesses in the door required to insert the mounting members may be milled in the manufacturing process at the same time as the recesses for the lock, which also lowers the production costs. Thus, the installation work on site is limited to mounting the stop elements on the side surface of the door leaf and to add the handles, which also control the axial mounting. There is no requirement for other installation steps. Errors in the installation process are precluded to a maximum extent.

The transmission of force, which is different in this unconventional construction, from the handle to the stop element, from the latter to the lock and from the latter (via the astragal) to the door leaf has not shown a weakness despite exhaustive testing. On the contrary, the actuating handle is always mounted permanently and reliably on the door leaf. It resists permanently even strong torque and force at crosswise direction, such as they may strike the object. Thus, the requirement to attach the rosette by screws, as had been the norm with its associated costs, has been shown to be unnecessary.

The embodiment of the stop elements as flat elements opens completely new design options, because the stop element is not very thick. The previously normal underbody with a mounted cover is no longer required, which will lower the production costs as well as the installation labor requirement.

Other variations arise, if the stop element has at least a step-shaped side. This would permit it to lie flush on the door leaf or to be at least partially inserted, such that it presents a most elegant and non-assertive form. Nonetheless, if needed, the stop element may also be embossed with a profile or an enhancement or such enhancements may be added as separate elements.

Preferably, at least one segment of the stop element will have a level rear surface, which will support the mounting member. It may be solidly attached to the stop element, such as by welding, soldering or gluing. However, it is also feasible to design the mounting member as part of the stop element or to attach it to the latter by detachable means. The significant feature is that the mounting member is no longer visible from the front of the stop element, such that no additional covers would be required. This will further reduce production costs and will also reduce storage costs and installation costs significantly.

It is advantageous to design the mounting member to be parallel to the longitudinal axis of the stop element, such that it will always be mounted in the lock with precision, but without loose play. The mounting member is also embodied as a bolt or sleeve, where its cross section may be round or with corners. A cross section with corners by itself would assure prevention of undesired rotation.

In order to assure an optimal transfer of force, the mounting member is designed such it will extend through at least a segment of the lock, once the actuating handles are mounted. Thus, the mounting member will always find sufficient support within the lock, such that the stop element is fixed in position without play and looseness.

In order to match the actuating handle to various locks, the invention provides that the dimensions of the mounting members may be modified, such as by pushing a bushing, a sleeve or the like onto the mounting member or allowing such an item to be pushed on. An appropriate bushing or sleeve may be chosen to match the diameter of the through holes designed for the lock. This will always assure a tight and solid fit of the mounting members in or on the lock.

In order to keep the stop element from twisting or moving relative to the door leaf, it is advantageous to provide for at least two mounting members. Another important embodiment of the invention designs them as a matching pair, such that any set of two mounting members will make contact or will join to form a single mounting member. This will also have the advantage that all stop elements will be identical, regardless of whether they are mounted on the right or left side surface of the door.

The invention further proposes that at least one mounting member is embodied as a sleeve and at least one additional mounting member is embodied as a pin, where the interior diameter of each sleeve corresponds to the exterior diameter of the pins. Thus, each pin is fully and firmly inserted into a sleeve, which in turn is fully and firmly held in the lock. The stop elements will thus be affixed perpendicularly to the longitudinal axis of the cover without play and looseness and without requiring additional mounting or securing hardware or even tools.

An alternative embodiment provides that each mounting member is formed from two identical segments, which jointly form a pin or sleeve that may be affixed perpendicularly to the longitudinal axis of the stop element on and/or in the lock. These pairwise joining elements will likewise hold the stop elements firmly and without looseness on the door leaf.

In order to actuate the door or the door leaf, the handle may be linked with the stop element such as to preclude axial and/or rotational movement. In order to operate the lock as well, the handle may be held in the stop element such that it may be turned and/or moved, where the preferred movement rotates around the longitudinal axis of the stop element.

To operate the lock integrated in the door, the handle is linked to a transmission element, which is preferably embodied as a shaft, specifically a shaft with four corners.

An additional important embodiment of the invention provides that the handle is axially and solidly connected to the transmission element or could be so connected. This also holds the stop element axially on the door leaf, such that the axial position of the stop elements will likewise no longer require specific fasteners or securing elements.

A bearing will be included between the handle and the stop element, such that the handle will always be supported in a fixed position and with a minimum of friction. The bearing is preferably a slide element of a slippery material, such as a plastic ring, which also reduces the production costs. But the bearing may also be a roller bearing assembly, if the actuating handle is subject to severe loads, for example.

An additional embodiment of the invention provides that the handle will be operated to counter a restoring force. This will always be of advantage if the restoring force of the lock by itself is insufficient to move the handle always back to its original position with sufficient reliability.

The restoring force will preferably be produced by a reversing device. Its structure and function is known from German Patent Application No. DE 20 2005 004 381 U1 or European Patent Application Publication No. EP 1 703 044 A2, to Engel et al., for example, which patent application is hereby incorporated herein by reference in its entirety.

The reversing device is preferably firmly linked to the stop element to prevent it from turning. It is also linked to the handle, such that the reversing spring provided within the reversing device will always be capable of reversing the handle.

There are particular advantages, if the reversing device is embedded or embodied in a receiving element, where the receiving element is embodied with a recess to house the reversing device. As a consequence, it will be simple and require no additional aids to insert it in the receiving element.

There is an additional advantage that the actuating handle can be designed on a building block component basis, when, for example, the various components (stop element, handle, shaft with four corners, reversing device) can be combined in any manner, such that the customer or the installer can decide on site which components will actually be used. However, it is also feasible to complete the fitting at the factory.

The receiving element is preferably located on the rear surface of the stop element and is thus not visible to the outside. This is also achieved, if the external measurements of the stop element perpendicular to the longitudinal axis of the stop element is larger than the external measurements of the receiving element. The latter is also solidly connected to the stop element, which may be done in an elegant manner by the mounting members, inasmuch as the receiving element is pushed onto these and thus onto the stop element. Alternatively, one may also embody the receiving element as a single piece with the stop element.

An additional important embodiment of the invention provides that the rotational or lateral movement of the handle relative to the stop element may be locked or blocked by a locking device. This includes at least one inhibitor to lock or block the handle, such that the door may be locked from at least one side. The inhibitor of the locking device can be operated by at least one lever, which preferably rotates and/or moves in or on the stop element.

It is thus not a requirement that the lock housed within the door must have a separate locking device. Rather, it may be embedded in the actuating handle, which would lower the costs significantly. This would also reduce the space required for the lock within the door leaf, which will also have a favorable influence on production and tooling costs. It is advantageous with regard to the construction, if the locking device is at least partly housed or embedded in the receiving element, where it is advantageous that the latter will have an additional recess to house the locking device.

This facilitates the inclusion of the locking device as well as the reversing device in the building block system.

There are additional advantages, if the locking device is embodied as a mirror image perpendicular to the longitudinal axis. The actuating handle may then be used at any time on the left side as well as on the right side.

The listed advantages of the actuating handle of the invention apply particularly when it is used on a door, where normally each side surface of the door leaf will have one actuating handle. The stop elements will simply be mounted on both sides on the door surfaces, where the mounting members will make contact with each other and will jointly be inserted into the lock, thus affixing the cover radially to the longitudinal axis of the stop elements. It will be advantageous that the actuating handles will be located on opposite sides and in line with the longitudinal axis of the stop elements.

The lock is mounted in the face of the door leaf of the door. This is preferably a mortise lock, which can be affixed in the door leaf by means of an astragal. The lock will also contain a turnable lock socket for operation of the latch.

It is important that the lock contains at least one through hole, a through bore or the like to house the mounting members for the stop elements, where it is possible to include at least two of these through holes symmetrically to the lock socket. This will always be the case, if a normed lock is used, such as a mortise lock in accordance with DIN 18 251 or Ö-Norm B 5350. Use of a normed lock will have the advantage that the through holes in the lock required to house the mounting members do not have to be drilled separately. Rather, they may be inserted without additional work, which also reduces the costs for production and installation.

In order to use the door also for bathrooms and toilets, the lock will be equipped with at least one additional through hole. This may be embodied as a through bore, a through sleeve or an additional lock socket, as are included in various widely available locks.

It is important that the mounting members of opposite stop elements are situated and/or designed such that they will fit tightly and frictionless in one of the through holes of the lock, when the actuating handles are installed, where it is preferable that in each case two opposite mounting members will tightly fit in a through hole.

The entire installation for the stop elements thus reduces to the mere axial insertion of the mounting members in the through holes of the lock. Once the mounting members are inserted in the through holes and the stop elements lie flush on the side surfaces of the door, the fitting is secured perpendicular to the longitudinal axis of the stop elements on the door leaf without play and movement. Radial shifts or rotation will no longer be possible.

A particular embodiment of the invention provides that each pin of a first stop element in the mounted position on the first side surface of the door will be inserted into the sleeve of a second stop element on the second side surface of the door, where each sleeve will be inserted into an associated through hole of the lock. The mounting elements of the stop elements are thus merely pushed into each other. No other installation steps or special mounting members will be required.

Another embodiment of the invention provides that a segment of a first stop element on the first side surface of the door and a matching segment of a second stop element on the second side surface of the door will jointly form a pin or sleeve-like element when the actuating handles are mounted, which is inserted into a through hole of the lock. As above, the paired opposite stop elements will join, where they as well as the elements in the previously discussed embodiment may be identical in shape. There is no need to distinguish between left and right stop elements. The production and storage costs are minimized.

In order to insert the mounting members of the stop elements through the door leaf, each side surface of the door will have at least one recess. It is advantageous here that opposing recesses are concentric to each other in the direction of the longitudinal axis of the fitting. This will also reduce production costs, since all recesses may be embodied as through bores.

At least one first recess will be so situated and/or embodied that the lock socket of the lock will be freely accessible through the side surfaces of the door leaf. At least one additional recess will be so situated and/or embodied that at least one through hole of the lock will be freely accessible for the insertion of the mounting members through the side surfaces of the door leaf. Furthermore, at least one additional recess will be so situated and/or embodied that at least one additional through hole of the lock will be freely accessible for the locking device through the side surfaces of the door leaf.

In order to provide an optically clean and pleasing design, the external dimensions of the stop element perpendicular to the longitudinal axis of the stop element are embodied such that all recesses will be fully covered by the stop element.

Another important embodiment of the invention provides that the first recess in the door leaf will be situated and embodied such that the lock socket, the through holes for the mounting members and/or the additional through holes for the locking device will be freely accessible through the door leaf. This requires that only a single recess must be milled or drilled through the door leaf, which minimizes the production costs for the door leaf itself.

In order to cover the recess completely, the external dimensions of the stop element perpendicular to the longitudinal axis of the stop element will exceed the interior diameter of the recess.

It is also feasible, however, to embody the edge of the stop element with steps to lie on the side surface. This approach would allow the stop element to reach a certain distance into the recess, such that only a very thin disk will be visible on the door surface. The stop element will thus give the cover a particularly elegant and unassuming look, without reducing its stability or strength. Thus, a door embodied according to the invention will provide completely new design options.

It is also possible to keep the stop elements from turning, if the external shape of the receiving elements for the reversing device and/or the locking device perpendicular to the longitudinal axis of the stop element will match the interior shape of the recess. It is not absolutely required that the latter is circular. It may also have a star shape or may be triangular.

Yet another design can be embodied, if the external shape of the stop element matches the internal shape of the recess perpendicular to the longitudinal axis. The stop element may now be situated and/or embodied level with the side surface of the door leaf, such that the door will have a completely level and smooth surface.

In order to house the reversing device and the locking device, the external dimensions of the receiving element perpendicular to the longitudinal axis of the stop elements will always be less than the interior measurements of the recess. The receiving element may thus be mounted in the recess together with the stop element, without being visible to the outside.

Another important embodiment of the invention takes an additional step with regard to the omission of traditional mounting elements.

It is proposed in this regard that the additional recesses to insert the mounting members in the side surfaces of the door and the corresponding through holes in the lock will have the same internal diameter, where the additional recesses in the side surfaces of the door and the lock within the door leaf will be positioned such relative to each other that the additional recesses and the through holes will be congruent or coaxial and/or will be superimposed with congruence.

Furthermore, at least one mounting member of the opposing stop elements will be situated and/or embodied such that it will extend into one of the additional recesses of the door and one of the through holes in the lock when the actuating handles are mounted perpendicular to the longitudinal axis, preferably with a tight fit and/or no movement. As mentioned above, it is possible here that the mounting members will engage or complete each other, such that a tight installation is assured.

Inserting the mounting members of the stop elements sideways into the recesses in the door leaf and into the through holes in the lock will not only fix the stop elements radially relative to the door leaf, but also relative to the lock itself. There is thus no longer a need to attach it to the door leaf by special screws and the astragal. The installation effort is rather reduced to the sideways insertion of the stop elements or the mounting members. Once the handles are axially fixed by the transmission element, the installation is completed. The time and cost required is substantially reduced relative to traditional processes.

The invention also provides that the handles of opposing actuating handles will be axially linked or linkable via the transmission element, such as by traditional setscrews

However, yet another embodiment of the invention proposes that the handles and the transmission element are or may be firmly attached to each other, specifically by including a device between at least one handle and the transmission element, which is designed to permit the insertion of the transmission element into the handle in a first direction and blocking it in a second direction.

The structure and function of such a device are known from the above incorporated by reference U.S. Patent Application Publication No. US 2006/0202491 A1.

Such an embodiment of the invention makes it feasible to mount the lock as well as the actuating handles without any tools and without separate or additional mounting members on a door leaf. Once the lock is inserted into the intended pocket in the door leaf and it is moved into the proper position, the stop elements need to be merely pushed onto the door leaf and the handles are then pushed onto the transmission element in an axial direction, thus in the longitudinal direction of the stop elements. Once the handles make lateral contact with the pivot shoe of the stop elements, the entire system, including the lock, is completely and permanently mounted. The mounting members of the stop elements affix the latter as well as the lock perpendicular to the longitudinal axis of the fitting in the door leaf, while the handles provide the axial positioning.

Thus, the invention facilitates an installation of a mortise lock and a door fitting without any tools.

Further characteristics, details and advantages of the invention derive from the wording of the claims and from the following description of embodiments by way of the drawings.

### DESCRIPTION OF THE DRAWINGS

These and other advantages of the present invention are best understood with reference to the drawings, in which:

FIG. 1 is a schematic oblique view of a door according to the invention with two actuating handles according to the invention;

FIG. 2 is a schematic oblique view of a door leaf;

FIG. 3 is an exploded oblique view of two actuating handles according to the invention, each with a reversing device and a locking device;

FIG. 4 is the actuating handles of FIG. 3 in an installed position;

FIG. 5 is a top view of one of the actuating handles of FIG. 3 in unlocked position;

FIG. 6 is a top view of one of the actuating handles of FIG. 3 in locked position;

FIG. 7 is an additional embodiment of a door according to the invention with two actuating handles according to the invention;

FIG. 8 is yet another embodiment of a door according to the invention with two actuating handles according to the invention;

FIG. 9 is another embodiment of an actuating handle;

FIG. 10 is a stop element with a receiving element for the reversing device;

FIG. 11 is an additional embodiment of a stop element; and

FIG. 12 is an additional important embodiment of a door according to the invention with two actuating handles according to the invention.

### DETAILED DESCRIPTION OF THE EXEMPLARY EMBODIMENTS

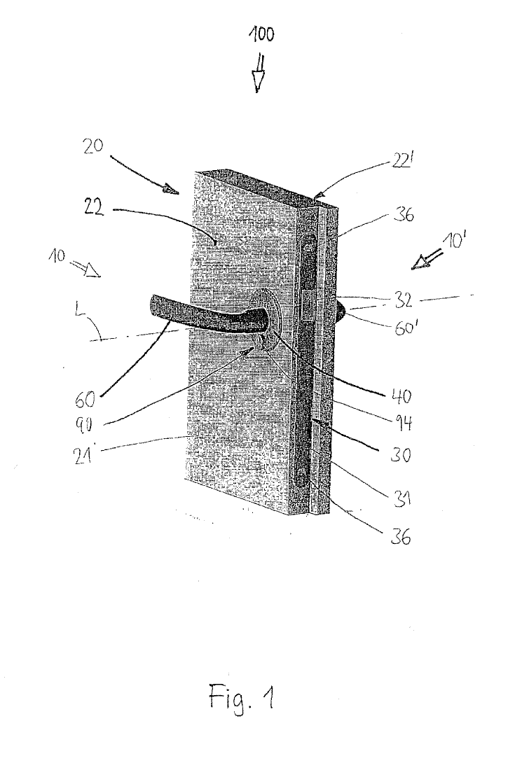

The door assembly denoted generally as 100 in FIG. 1 includes a door 20 with a door leaf 21, which is supported by means of hinges (not shown here) on a doorframe (likewise not shown here) such that the door can be opened and closed. The face of door leaf 21 contains lock 30, which is embodied as a mortise lock. It is positioned and affixed to door leaf 21 by astragal 31. This is designed to be handled by screws 36, which are screwed through astragal 31 into door leaf 21. A latch 32, which extends through astragal 31 and which may be adjusted in a longitudinal direction, hooks into a lock plate in the doorframe (not shown here) when door 20 is in a closed position. In the present case, door 20 is depicted as a rebated door. However, it may also be an unrebated door.

The side surfaces 22, 22′ of door leaf 21 each support an actuating handle (sometimes referred to as a fitting) 10, 10′, where each actuating handle 10, 10′ is embodied as a door fitting with stop element 40, 40′ in flat contact with door leaf 21 and a movable handle 60, 60′, such as a doorknob.

The two actuating handles 10, 10′ are situated opposite each other and in line with the longitudinal axis L of stop elements 40, 40′. Handles 60, 60′ serve to open and close door 20 as well as to actuate lock 30 contained in door 20.

The embodiment shown in FIG. 1 shows door 20 as a bathroom or toilet door. At least one fitting 10, 10′ contains a locking device 90, which can be operated by a lever in the form of an additional handle 94. It is feasible to produce door 20 also without locking device 90 as a simple interior door for houses, specifically if there is no need to lock door 20. If so, locking device 90 and operating elements 94, 94′ are not needed.

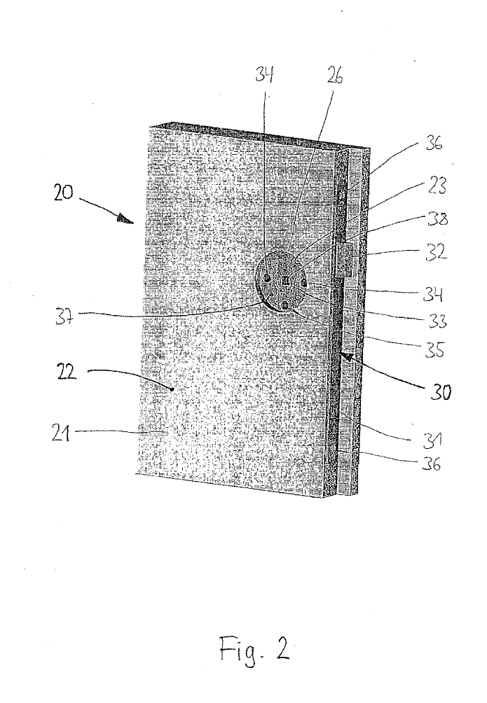

FIG. 2 shows door 20 from FIG. 1 without fittings 10, 10′. It shows that mortise lock 30 to operate latch 32 has a lock socket 33, which rotates in housing 37 of mortise lock 30 and which is linked to latch 32 in a known manner. Housing 37 of mortise lock 30 has two through holes 34 to the side of lock socket 33 and in symmetrical distances from it, where these preferably consist of simple drill holes. It is feasible to insert sleeves in through holes 34, which may be tightly inserted into housing 37, for example. There is an additional through hole 35 below lock socket 33, which may likewise be either a bore or a sleeve.

The distance between through holes 34, 35 and to lock socket 33 correspond to usual normed sizes, such as those of DIN 18 251. The same applies to the position and form of lock socket 33 as well as the dimensions of housing 37. Thus, the invention provides for the option of embodying lock 30 as a conventional DIN lock, which is advantageous to shipment and total costs.

FIG. 2 also shows a recess 23 in door leaf 21 on the visible side surface 22; there is also a recess 23′ in the side surface 22′ not shown here. Their dimensions and position on door leaf 21 are chosen such that lock socket 33 and through holes 34, 35 in mortise lock 30 are freely accessible through door leaf 21 from both sides. It is preferable that recesses 23, 23′ are congruent and/or concentric to each other. This has the advantage that recesses 23, 23′ may be embodied as simple through bores perpendicular to the cutout (not shown here) in door leaf 21 for mortise lock 30. This will simplify the production of door leaf 21 significantly.

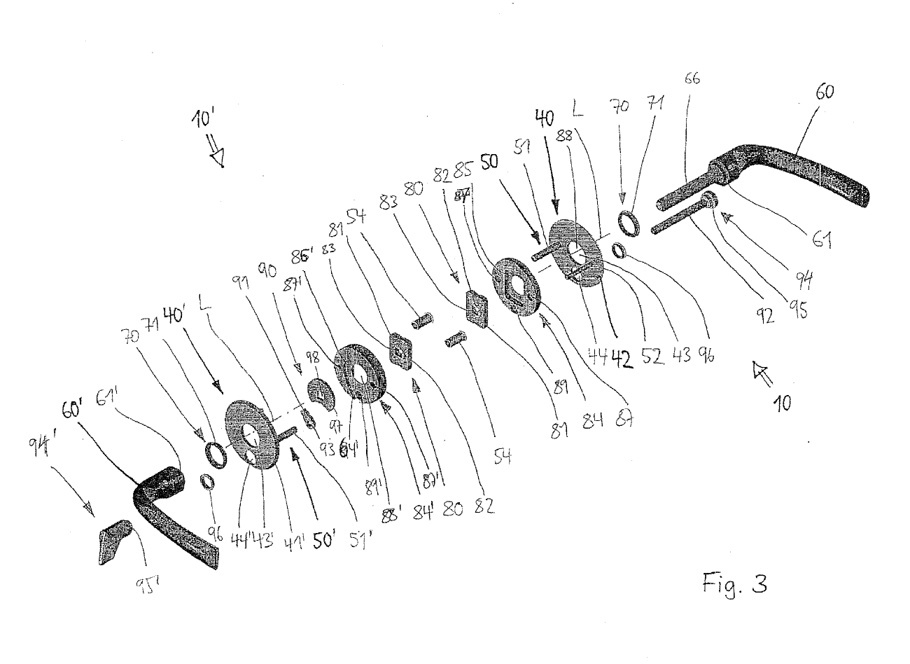

FIG. 3 shows more closely that stop element 40, 40′ of each actuating handle 10, 10′ is embodied as a simple flat disk, the edge of which may by a chamfered edge 41 (not illustrated in the drawings.), 41′. The center of disks 40, 40′ has a circular recess 43, 43′ for insertion of handle 60, 60′. Below it is an additional recess 44, 44′ for insertion of levers 94, 94′ of locking device 90.

Stop elements 40, 40′ are affixed to door leaf 21 not by screws or bolts, as is traditional, but by specialized mounting members 50, 50′ attached to the flat rear surface 42, 42′ of each stop element 40, 40′ and which may be inserted through side surfaces 22, 22′ of door 20 or of door leaf 21 into the through holes 34 in housing 37 of lock 30 (not shown in FIG. 3).

Given that the position of through holes 34 in lock 30 is fixed by a norm, each stop element 40, 40′ supports two mounting members 50, 50′, which extend parallel to the longitudinal axis L of stop elements 40, 40′. Mounting members 50, 50′ are also positioned symmetrically and at equal distances from recess 43, 43′ for handle 60, 60′, such that recess 43, 43′ will always be oriented coaxially to the axle of rotation of lock socket 33 when fitting 10, 10′ is mounted.

The first mounting member 50, 50′ is embodied as sleeve 51, 51′, which is preferably butt-welded onto rear surface 42, 42′ of stop element 40, 40′. The second mounting member 50, 50′ is embodied as a stud or as pin 52, 52′, which is also butt-welded onto stop element 40, 40′. It is also feasible to glue stud or sleeve 51, 51′, 52, 52′ onto stop element 40, 40′ or to produce a single component. It is also conceivable to produce a removable attachment. It is always important that mounting members 50, 50′ cannot be seen from the outside, such that no additional covers for stop elements 40, 40′ are required.

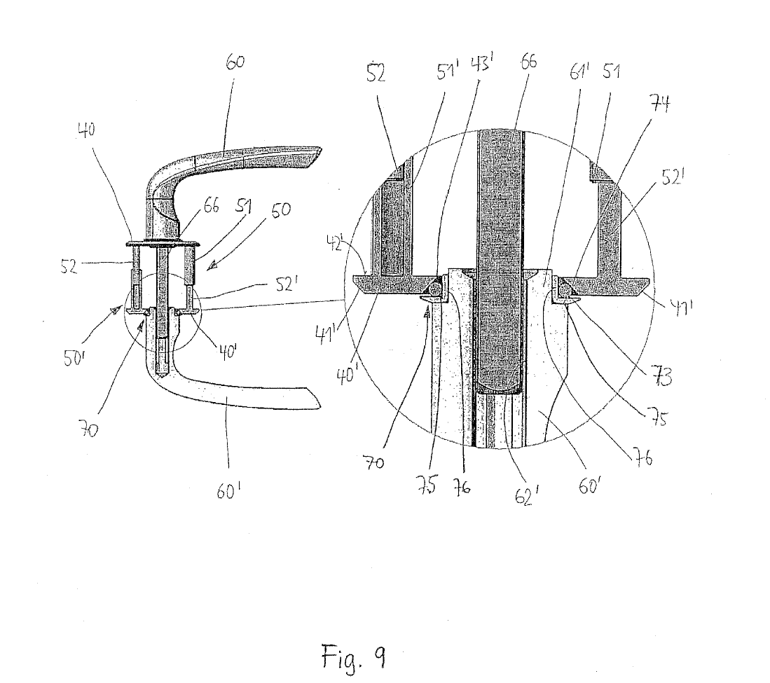

FIG. 3 shows that each stop element 40, 40′ is associated with a sleeve 51, 51′ and a pin 52, 52′, where the exterior diameter of pin 52, 52′ matches the interior diameter of sleeve 51, 51′. Two stop elements 40, 40′ located on side surfaces 22, 22′ of door leaf 21 opposite each other can thus be inserted into each other within lock 30 with matching mounting members 50, 50′ such that sleeve 51 of the first stop element 40 houses the opposite pin 52′ of the second stop elements 40′, while its sleeve 51′ houses pin 52 of the first stop element 40. The length of mounting members 50, 50′ is chosen such that pins 52, 52′ will always be reliably secured within sleeve 51, 51′ regardless of the thickness of the door leaf (see FIG. 9, for example).

Stop elements 40, 40′ are thus identical, i.e. they may be used on the left side or the right side. The installation of actuating handle 10, 10′ is thus very simple. Errors in installation are impossible. Proper matching of the internal and external diameters can generate friction when mounting members 50, 50′ are pushed into each other, which is beneficial to the stability of the connection.

While pins 52, 52′ of the stop elements are firmly seated in sleeves 51, 51′, the latter are mounted firmly in through holes 34 in housing 37 of lock 30. The external diameter of sleeves 51, 51′, which are parallel to each other, is chosen such that mounting members 50, 50′ will always be held firmly in lock 30. This creates a permanent, reliable and firm adherence perpendicular to the longitudinal axis L of stop elements 40, 40′, i.e. stop elements 40, 40′ are also fixed in position radially to longitudinal axis L by means of the mortise lock 30 inserted into door leaf 21. Given that each stop element 40, 40′ has two mounting members 50, 50′, this also assures that the assembly cannot rotate. There is no need for an additional cam that would need to be inserted into door leaf 21 at added cost or other mounting members.

If there are plans to use various mortise locks, specifically locks with dimensions that do not satisfy established norms, it is advantageous that the dimensions of mounting members 50, 50′ be adjustable. This is contemplated in the embodiment shown in FIG. 3, where additional sleeves 54 may be pushed onto sleeves 51, 51′. Their diameter matches the internal diameter of through holes 34 in the various mortise locks 30, such that stop elements 40, 40′ will always be firmly affixed perpendicular to their longitudinal axis L on side surfaces 22, 22′ of door 20. As is done in a building block system, sleeves 54 in various diameters may be included with actuating handles 10, 10′, such that the installer or the customer may decide on site which element to use for the installation in question.

Each handle 60, 60′ with its stepped tapered handle neck 61, 61′ rotates in the central recess 43, 43′ of stop element 40, 40′, where a bearing 70 is included between handle neck 61, 61′ and stop element 40, 40′. This achieves a good movement of handle 60, 60′ relative to stop element 40, 40′. It also reduces friction and wear.

As shown in FIG. 3, bearing 70 may be a simple sliding bearing 71 embodied as a plastic ring. However, bearing 70 may also use a roller bearing assembly 72 (not illustrated in the drawings) with rolling elements 73, as shown in FIG. 9, which are placed between handle neck 61, 61′ and stop element 40, 40′. Rolling elements 73—for example, spherical or cylindrical bodies—will roll on faces 74, 75, where a first face 74 consists of the beveled edge of recess 43, 43′, while the edge of handle neck 61, 61′ is the second face 75. The second face 75 is preferably embodied as a separate (ring) element 76, which also forms a (movement-restricting) cage for rolling element 73. The roller bearing assembly 72 (not illustrated in the drawings) may be prefabricated as a separate component and may be inserted into fitting 10, 10′ if needed. FIG. 9 shows that the height of fitting 10, 10′ is hardly modified by roller bearing assembly 72 (not illustrated in the drawings). The flat and elegant overall design of stop elements 40, 40′ is not impacted by the significantly better operation of the handle.

Two handles 60, 60′ are connected by a transmission element 66 to operate lock 30 in door 20. This is preferably a four-cornered shaft, which extends into handle necks 61, 61′ of handles 60, 60′ and which extends through lock socket 33 of lock 30, when fitting 10, 10′ is installed. The lock socket contains square hole 38 for this purpose. Handles 60, 60′ contain matching recesses 62 (not illustrated in the drawings), 62′, which contain the four-cornered shaft 66 tightly, such that it is rotationally fixed.

Once handles 60, 60′ have reached their final positions in stop elements 40, 40′ and their handle necks 61, 61′ are seated in bearings 70, handles 60, 60′ are axially locked onto four-cornered shaft 66, for example by setscrews. However, it is also feasible to mount the four-cornered shaft 66 in the factory into handle 60 (the so-called pin component). In that case, the only step left is to affix four-cornered shaft 66 in the opposite handle 60′ by hand.

Once handles 60, 60′ are mounted on four-cornered shaft 66, fitting 10, 10′ is mounted completely, where no tools are required to affix stop elements 40, 40′. The latter are merely inserted from the side into mortise lock 30, which is pre-mounted in the side of door leaf 21, which then concludes the installation process. Mounting members 50, 50′ secure stop elements 40, 40′ radially within the door plane, while handles 60, 60′ provide the axial lock.

A particularly preferable embodiment of the invention provides furthermore that a device (not shown here) is placed between at least one handle 60, 60′ and the four-cornered shaft 66 designed such that the four-cornered shaft 66 can be inserted into handle 60, 60′ in a first direction, but that it is blocked in the opposite direction. Such a device is known from the above incorporated by reference U.S. Patent Application Publication No. US 2006/0202491 A1.

This makes if feasible to install handles 60, 60′ without tools. The four-cornered shaft 66 is merely inserted into the handle neck 61, 61′ of handle 60, 60′ as usual. It is then no longer possible to pull it out in the opposite direction, because the device acts as a block and holds the transmission element 66 in the handle. It does not matter how far the four-cornered shaft 66 is inserted into handle 60, 60′. Once the blocking device has made contact with shaft 66, it is held fast—preferably in an axial direction—and cannot be removed from handle 60, 60′. An example of such a blocking device may be found, for example, in U.S. Patent Application Publication No. US 2006/0202491 A1, to Engel et al., which patent application is hereby incorporated herein by reference in its entirety. Differences in the thickness of the door are handled automatically—as is the case for joined mounting members 50, 50′—i.e. handle 60, 60′ is merely pushed on until contact is made and it is then firmly attached to stop element 40, 40′. The device holds the four-cornered shaft 66 so tightly in handle 60, 60′ that actuating handle 10, 10′ will withstand even high loads permanently.

It is not possible to disengage or loosen it accidentally. Four-cornered shaft 66 is neither noticeably damaged nor deformed when it is secured, such that it may be reused after a disassembly. It is feasible here as well to pre-mount four-cornered shaft 66 in one of the handles 60, such that only the opposite handle 60′ will need to be affixed by means of the locking device.

However, this means that no tools of any kind will be required to install fittings 10, 10′ in accordance with the invention. Neither to affix the stop plates 40, 40′ nor to secure handles 60, 60′ axially. Once they are in their final position, fitting 10, 10′ is installed in its entirety. The time required for this process is minimized. There is neither a requirement to drill holes into door leaf 21 based on drilling templates, nor is it necessary to provide screws or other fasteners. Fitting 10, 10′ will be affixed directly to mortise lock 30, which is normally pre-installed in door 20 anyway.

To assure that handle 60, 60′ will return to its usually horizontal original position after each use, it is advantageous to include a so-called return spring or returning spring in fitting 10, 10′. To this end, it is proposed to operate handle 60, 60′ against the force exerted by reversing device 80.

Reversing device 80 is shown in the embodiment depicted in FIG. 3 as a return spring unit, which is rotationally linked to stop element 40, 40′ as a pre-installed unit and which is linked to handle 60 by the four-cornered shaft 66. The structure and function of the reversing device 80 are described in the above incorporated by reference German Patent Application No. DE 20 2005 004 381 U1 or European Patent Application Publication No. EP 1 703 044 A2. The reversing device 80 consists essentially of a two-part housing 81, in which socket 82 may rotate, where socket 82 has two radially extending tabs, where the center of socket 82 has square hole 83 for the insertion of four-cornered shaft 66, which may be rotated around its axis for a limited angle subject to the tension of the spring.

In order to affix the reversing device to stop element 40, 40′, the reversing device 80 is inserted into receiving element 84, 84′, which includes a matching recess 85, 85′ (not illustrated in the drawings). Its height corresponds essentially to the height of the two-part housings 81, such that the reversing device 80 is inserted flush with receiving element 84, 84′. The latter is supported on the preferably flat rear surface 42, 42′ of the stop element 40, 40′ and is rotationally attached to it. To this end, receiving element 84, 84′ includes side bores 87, 87′, into which mounting members 50, 50′ are inserted to form a tight fit. Thus, if needed, receiving element 84, 84′ will be simply placed on the rear of stop element 40, 40′ and the reversing device 80 will be inserted in it. There is no need to use mounting members or other measures. Four-cornered shaft 66 extends through central cutout 88, 88′ in receiving element 84, 84′.

In order to avoid exposing receiving element 84, 84′ to external view, the external dimensions of stop element 40, 40′ perpendicular to longitudinal axis L of stop element 40, 40′ will always exceed the external dimensions of receiving elements 84, 84′, and in particular its external diameter will be smaller than the external diameter of stop element 40, 40′. At the same time, the external diameter of receiving element 84, 84′ will be smaller than the internal diameter of recess 23, 23′ in door leaf 21, such that each receiving element 84, 84′ will be inserted into the associated recess 23. 23′ when stop elements 40, 40′ are installed.

Locking device 90 is designed to provide a lock on door 20, if needed. This device will lock or block the rotation movement of handles 60, 60′ relative to stop elements 40, 40′, such that latch 32 of lock 30 cannot be retrieved and door 20 cannot be opened consequently.

To this end, locking device 90 has a rotating inhibitor 91, which is rotationally fixed on rotating shaft 92. It is preferable that the latter be embodied as a four-cornered shaft, of which both ends can be solidly linked with one lever 94, 94′ on either side of door leaf 21, where the levers can be embodied, for example, as an olive-shaped lever or lever 94′ on one side of door 20 and with a slotted head on the other side of door 20. Each lever 94, 94′ is seated on a stepped sleeve 95, 95′ and rotates in one each of recesses 44, 44′ in stop elements 40, 40′ on both sides of door 20, where bearing 96 is placed between each lever 94, 94′ and each stop element 40, 40′, where bearing 96 may be a plastic ring, which would assure good positioning of levers 94, 94′ and reduce friction due to its slippery characteristics.

Inhibitor 91 is preferably embodied as a rocking lever or pivoting lever, where one end of the lever has square hole 93, which fits tightly onto four-cornered shaft 92.

Four-cornered shaft 92 extends through stop elements 40, 40′, receiving elements 84, 84′, side surfaces 22, 22′ of door 20 and lock 30, where shaft 92 has such a radial distance to the pivot axle of lock socket 33 in mortise lock 30 that it extends through the additional through hole 35 in mortise lock 30 such that it can rotate. There is no requirement that the latter would need to be designed with an additional or special bore. Rather, it is feasible to continue to use a DIN lock that is widely marketed. Receiving elements 84, 84′ are designed with appropriate bores 89, 89′ to support shaft 92 such that it can rotate.

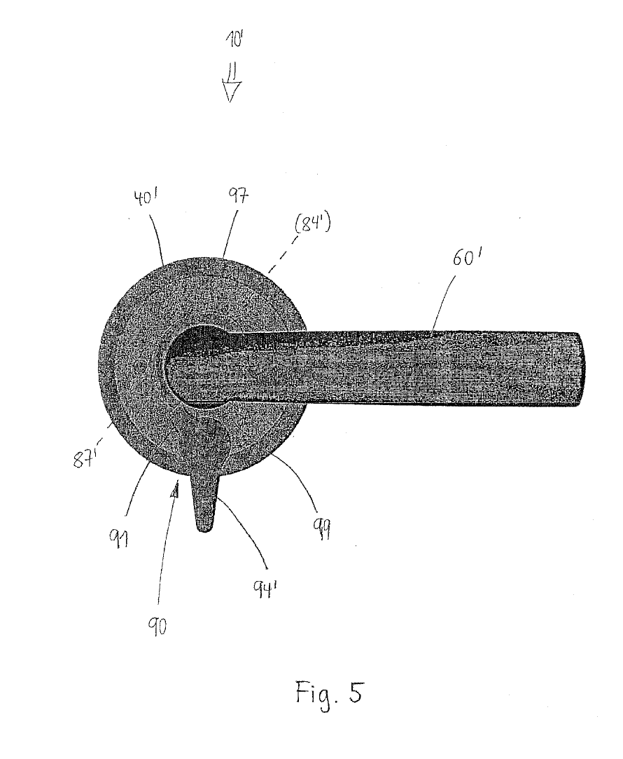

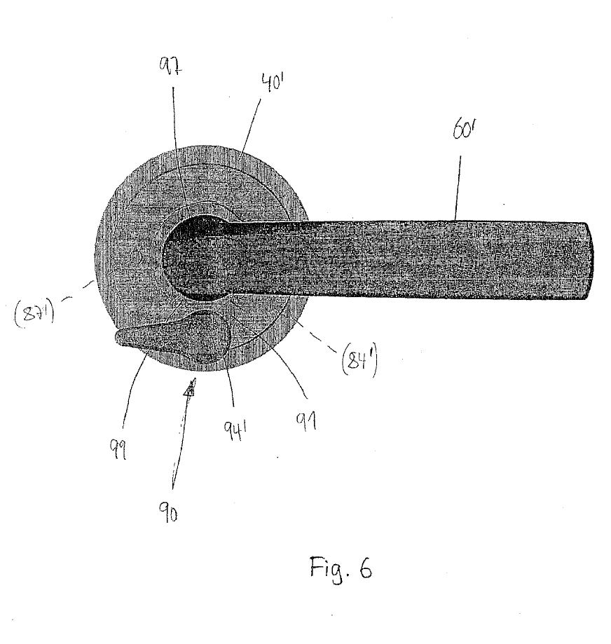

An additional recess 86′ to house inhibitor 91 is provided in at least one receiving element 84′opposite to recess 85′ (not illustrated in the drawings) for the reversing device 80. It has essentially a V-shape with two sides 64′ in the vicinity of bore 89′. The sides limit the rotational movement of inhibitor 92, and they thus serve as stop surfaces. FIGS. 5 and 6 show that inhibitor 91 is situated within additional recess 86′ of receiving elements 84′ such that square hole 93 for four-cornered shaft 92 is placed coaxially to bore 89′ in receiving element 84′. This is critical to permit installation of shaft 92 also after stop plates 40, 40′ and handles 60, 60′ have been installed.

Recess 86′ of receiving element 84′ includes disk 97, which may rotate, next to inhibitor 91. Its edge has a circumferential recess 99. Furthermore, it is concentric to the rotation axis of lock socket 33 and thus concentric to the rotation axis of handles 60, 60′, such that four-cornered shaft 66 can extend centrally through disk 97. A central square hole 98 keeps disk 87 from rotating on four-cornered shaft 66, where disk 97 is situated such when installed that circumferential recess 99 extends just above the free end of inhibitor 91.

FIGS. 5 and 6 show how locking device 90 functions, when it is installed vertically from longitudinal axis L and with mirror symmetry.

FIG. 5 shows that inhibitor 91 is turned to the left by lever 94′, where inhibitor 91 contacts the left side 64′ of recess 86′. When handle 60′ is now depressed to open the door, disk 97 can turn towards the right without constraint, because circumferential recess 99 is open towards the right side. Latch 32 is retracted. The door may be opened.

To lock door 20, inhibitor 91 is moved towards the right by lever 94′ until it makes contact on the right side 64′ of recess 86′. The free end of inhibitor 91 and the side edge of circumferential recess 99 face each other directly. Any attempt to turn handle 60′ will cause immediate contact between disk 97 and inhibitor 91. Handle 60′ cannot be moved. Door 20 is locked. This is shown in FIG. 6.

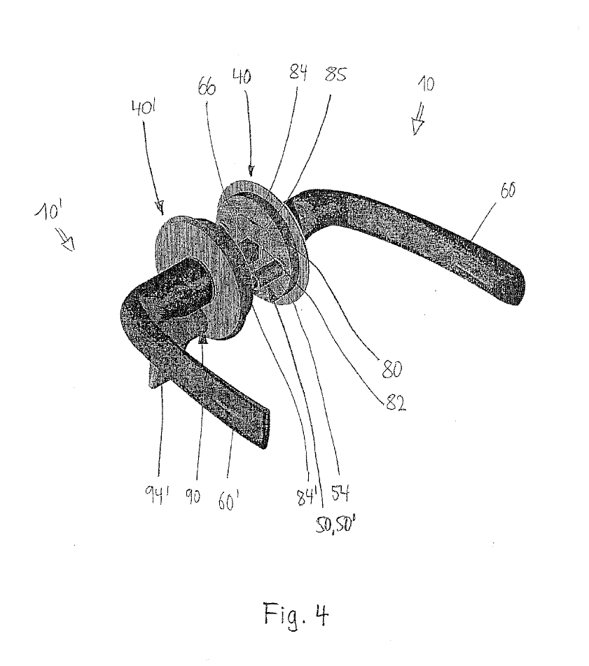

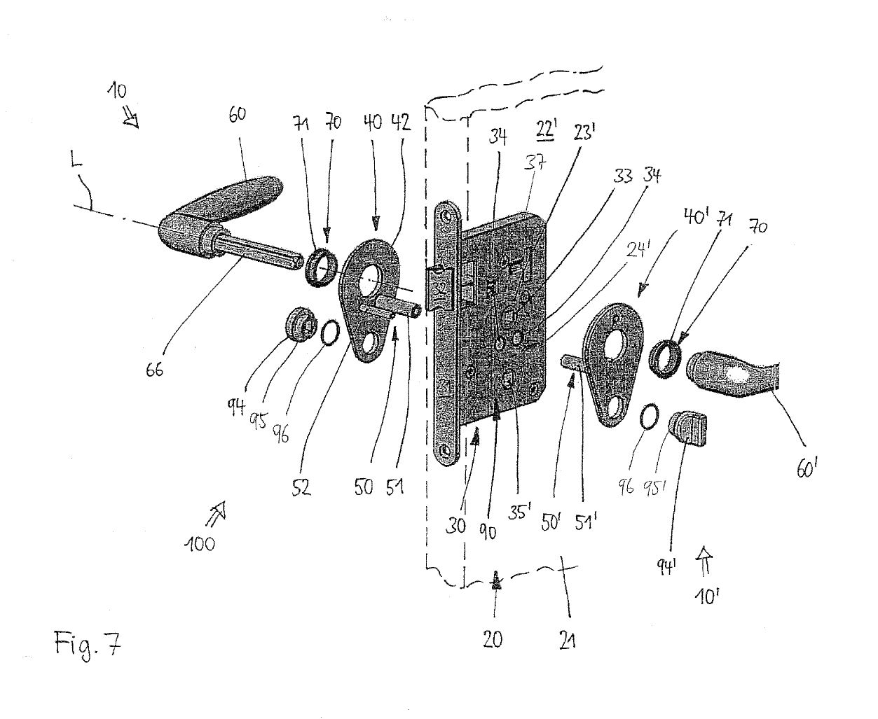

The installation of locking device 90 is also very simple. Once stop elements 40, 40′ are attached and handles 60, 60′ are inserted and secured, shaft 92 is inserted through recesses 44, 44′, through bores 89, 89′ in receiving elements 84, 84′, through the through hole 35 in mortise lock 30 and through inhibitor 91 until pre-installed lever 94, e.g. the slotted head, makes contact with bearing 96 of stop element 40. The opposite lever 94′ is then pushed onto the end of shaft 92 and is then locked axially onto the same. Levers 94, 94′ are attached to shaft 92 in the same manner as handles 60, 60′ are attached to four-cornered shaft 66.

Whereas locking device 90 of the embodiment shown in FIGS. 3 to 6 is separate and at least partially embodied in receiving element 84, 84′, the embodiment shown in FIG. 7 for lock 30 is a so-called latch lock, where components of locking device 90 are already integrated into housing 37 of lock 39. For example, locking device 90 includes an additional lock socket 35′ with a four-cornered hole (not specified in detail), into which four-cornered shaft 92 of locking device 90 is pushed such that it is rotationally fixed. This makes it feasible to lock or unlock door 20 by moving levers 94, 94′, which can rotate in stop elements 40, 40′.

In order to provide access to the additional lock socket 35′ through door leaf 21, additional recesses (also sometimes referred to as bores) 24 (not illustrated in the drawings), 24′ are inserted into door leaf 21 below recesses 23, 23′. Because the radial distance between lock socket 33 and the additional lock socket 35′ is larger than the distance between lock socket 33 and the additional through hole 35, stop elements 40, 40′ are not embodied as a round shape, but rather elongated shapes, such that recesses 23, 23′ and 24 (not illustrated in the drawings), 24′ in door leaf 21 will always be covered.

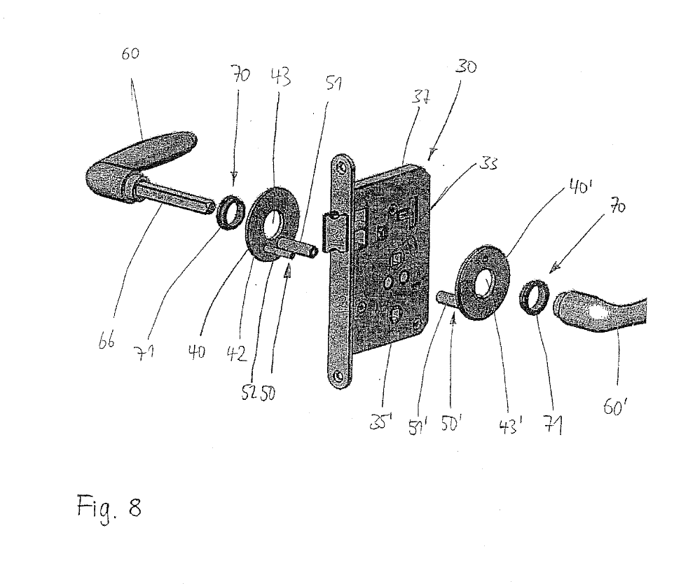

The embodiment shown in FIG. 8 omits the reversing device 80 as well as locking device 90, such that it includes neither receiving element 84, 84′ nor additional levers 94, 94′.

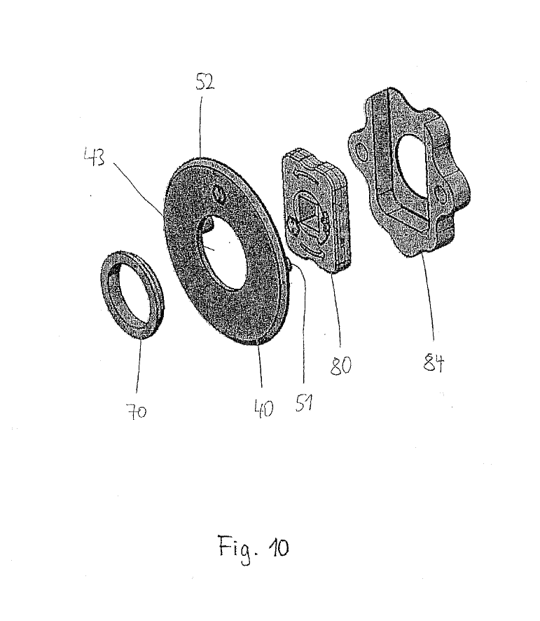

There is no requirement that receiving elements 84, 84′ for reversing device 80 and/or locking device 90 must be round or disk-like. As FIG. 10 shows, it is also feasible to design the external edge of receiving elements 84, 84′ in shapes other than round, such as star-shaped or with corners, specifically as a triangle. If so, recesses 23, 23′ (not shown here) in side surfaces 22, 22′ of door leaf 21 will be designed such that receiving elements 84, 84′ fit precisely into them, i.e. the external shape of receiving element 84, 84′ perpendicular to longitudinal axis L of stop element 40, 40′ matches the interior shape of recess 23, 23′. This has the advantage that it creates an additional or alternative protection against rotation. At the same time, only the special fittings 10, 10′ with these receiving elements 84, 84′ can be mounted on doors 20 thus designed, which can be an advantage to protect against copying.

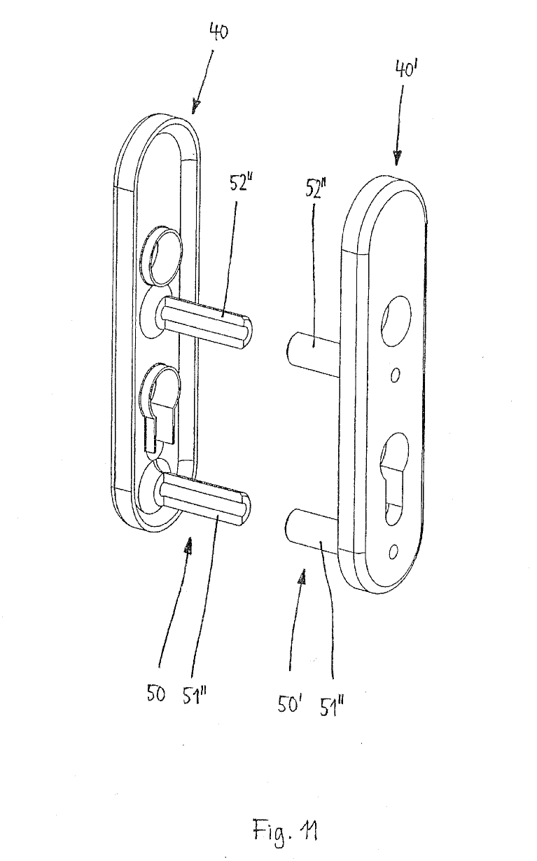

FIG. 11 shows a particular embodiment of mounting members 50, 50′. They are not embodied as separate sleeves or studs. Rather, each mounting member 50, 50′ consists of two identical segments 51″, 52″, which together form a stud-like or sleeve-like element. Segment 51″ of a first stop element 40 on first side surface 22 of door 20 and a matching segment 52″ of a second stop element 40′ on second side surface 22′ of door 20 join to form a stud-like or sleeve-like element when actuating handles 10, 10′ are installed, where this element is tightly inserted into the associated through hole 34 of lock 30.

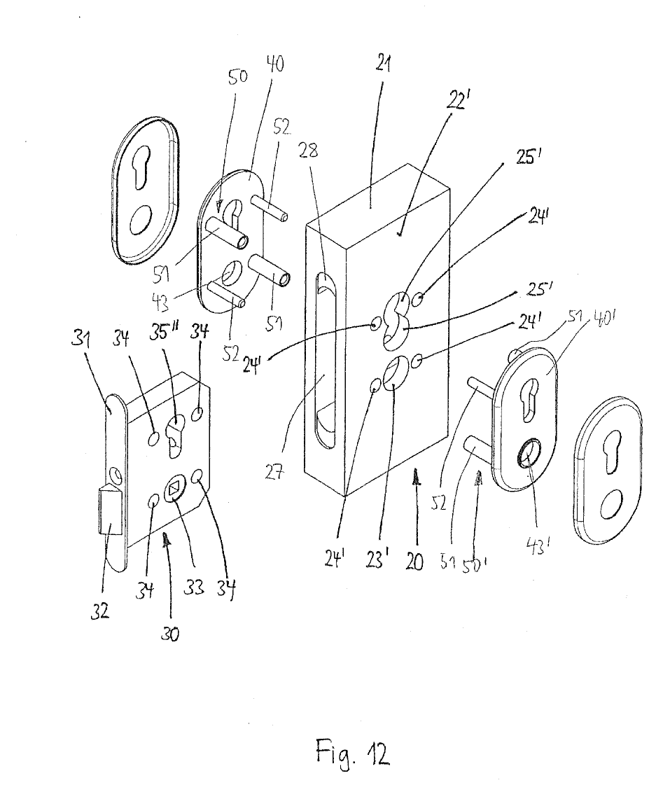

In yet another embodiment of the invention (see FIG. 12), the face of door leaf 21 has a pocket 27 for the insertion of mortise lock 30. Step-like ledges 28 are provided above and below this pocket for astragal 31, such that the latter will be mounted level with the face of door 20. Mortise lock 30 has a lock socket 33 and, above the latter, a through hole 35″ for a lock cylinder (not depicted here). Through holes 34 are included to the side of lock socket 33 and next to through hole 35″ with an internal diameter equal to the external diameter of sleeve 51.

Door leaf 21 includes recesses 23, 23′. These are only large enough that lock socket 33 of mortise lock 30 is accessible from the outside. Above recesses 23, 23′, there are additional recesses 25 (not illustrated in the drawings), 25′ in side surfaces 22, 22′, which facilitate access to through hole 35″ in mortise lock 30. To the side of recesses 23, 23′ and 25 (not illustrated in the drawings), 25′, there are bores 24, 24′, which also have an internal diameter equal to the external diameter of sleeve 51.

Consequently, the additional recesses 24, 24′ in side surfaces 22, 22′ of door 20 and through holes 34 in lock 30 have the same interior diameter. They are also symmetrical with respect to lock socket 33 and recess 23, 23′, and they have the same distance from each other.

If mortise lock 30 is inserted into pocket 27 such that the additional recesses 24, 24′ in side surfaces 22, 22′ of door 20 and the through holes 34 in the mortise lock are congruent to each other, then mounting members 50, 50′ of stop elements 40, 40′ will tightly fit into them when fitting 10, 10′ is installed.

Thus, mounting members 50, 50′ not only attach stop elements 40, 40′ to the door, but also mortise lock 30. In this regard, recesses 24 (not illustrated in the drawings), 24′ in door leaf 21 and through holes 34 in mortise lock 30 are configured such that astragal 31 will seat exactly on ledges 28. However, there is no longer a need for screws to attach astragal 31 to door leaf 21. Fitting 10, 10′ as well as mortise lock 30 can be installed without any tools at all.

The invention is not restricted to one of the embodiments described above, but may be modified in myriad ways.

For example, at least the edge of stop element 40, 40′ may have several indentations and stop element 40, 40′ may rest on side surface 22, 22′ on edge 26 of the first recess 23, 23′. This opens additional interesting design options. For example, the centers of stop elements 40, 40′ may be quite thick, but its edges may be relatively thin, such that stop element 40, 40′ hardly rises above side surfaces 22, 22′ of door 20

An additional variation proposes that stop elements 40, 40′ are inset in recesses 23, 23′ of the door, i.e. that the exterior shape of stop elements 40, 40′ perpendicular to the longitudinal axis L matches the internal shape of recess 23, 23′. Admittedly, this requires that the exterior dimensions of stop elements 40, 40′ and the interior diameter of recesses 23, 23′ match nearly exactly. However, this gives door 20 overall a completely level and smooth surface, which facilitates a particularly elegant design.

The cross section of mounting members 50, 50′ of stop elements 40, 40′ may be round or it may have corners. This will also secure against rotation, such that merely a single mounting member 50, 50′ for each stop elements 40, 40′ would be included.

Depending on the intended use of door 20, it is feasible to link one of handles 60, 60′ to stop element 40, 40′ axially or rotationally, e.g. if there is no intention of having door 20 open from this side.

If needed, receiving element 84, 84′ may also be integrated with stop element 40, 40′ as a single piece.

All of the characteristics and advantages, including details of design, spatial position and process steps, revealed in the claims, the description, and the drawings may be essential to the invention by themselves or in various combinations. Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

List of Reference Numbers

| L | longitudinal axis |
|---|---|
| 10 | actuating handle |
| 10′ | actuating handle |
| 20 | door |
| 21 | door leaf |
| 22, 22′ | side surface |
| 23, 23′ | recess |
| 24, 24′ | recess |
| 25, 25′ | recess |
| 26 | edge |
| 27 | pocket |
| 28 | ledge |
| 30 | lock |
| 31 | astragal |
| 32 | latch |
| 33 | lock socket |
| 34 | through holes |
| 35 | additional through hole |
| 35′ | additional lock socket |
| 35″ | through hole |
| 36 | screw |
| 37 | housing |
| 38 | square hole |
| 40, 40′ | stop element |
| 41, 41′ | chamfered edge |
| 42, 42′ | rear surface |
| 43, 43′ | recess |
| 44, 44′ | recess |
| 50, 50 | mounting member |
| 51, 51′ | sleeve |
| 52, 52′ | pin |
| 51″, 52″ | segment |
| 54 | sleeve |
| 55″ | element |
| 60, 60′ | handle |
| 61, 61′ | handle neck |
| 62, 62′ | recess |
| 64′ | side |
| 66 | transmission element |
| 70 | bearing |
| 71 | bearing |
| 72 | roller bearing assembly |
| 73 | rolling element |
| 74 | face |
| 75 | face |
| 76 | cage |
| 80 | reversing device |
| 81 | housing |
| 82 | socket |
| 83 | square hole |
| 84, 84′ | receiving element |
| 85, 85′ | recess |
| 86′ | additional recess |
| 87, 87′ | bore |
| 88, 88′ | cut-out |
| 89, 89′ | bore |
| 90 | locking device |
| 91 | inhibitor |
| 92 | (square) shaft |
| 93 | square hole |
| 94, 94′ | lever |
| 95, 95′ | sleeve |
| 96 | bearing |
| 97 | disk |
| 98 | square hole |
| 99 | circumferential recess |
| 100 | door assembly |

What is claimed is:

1. An actuating handle for a door comprising:
a stop element configured to be attached to the door by at least one mounting member; and
a handle configured to operate at least one of the door and a lock inserted into the door;
wherein the mounting member is linked to the stop element and is configured to be inserted into the lock through a side surface of the door; and
wherein the mounting member is configured to be affixed one of on and in the lock perpendicular to a longitudinal axis of the stop element.

2. The actuating handle of claim 1, wherein the stop element is a flat entity.

3. The actuating handle of claim 1, wherein the stop element defines a step shaped edge.

4. The actuating handle of claim 1, wherein at least a portion of the stop element defines a level rear surface.

5. The actuating handle of claim 4, wherein the mounting member is coupled to the rear surface of the stop element.

6. The actuating handle of claim 1, wherein the mounting member is parallel to the longitudinal axis of the stop element.

7. The actuating handle of claim 1, wherein the mounting member is one of a stud and a sleeve.

8. The actuating handle of claim 1, wherein the mounting member defines one of a round and a cornered cross section.

9. The actuating handle of claim 1, wherein the mounting member is configured to extend through at least a segment of the lock.

10. (canceled)

11. The actuating handle of claim 9, wherein the mounting member is configured to receive one of a bushing and a sleeve mounted on the mounting member.

12. The actuating handle of claim 1, wherein the stop element includes at least two mounting members.

13. (canceled)

14. (canceled)

15. The actuating handle of claim 12, wherein each mounting member includes two identical segments, which jointly form one of a stud and a sleeve-like element.

16. The actuating handle of claim 1, wherein the handle is at least one of axially and rotationally linked to the stop element.

17. The actuating handle of claim 1, wherein the handle is at least one of axially and rotationally supported in the stop element.

18. The actuating handle of claim 17, wherein the handle is configured to rotate about the longitudinal axis of the stop element.

19. The actuating handle of claim 17, wherein the handle is in operable communication with a transmission element configured to selectively actuate the lock.

20. The actuating handle of claim 19, wherein the transmission element is a four cornered shaft.

21. The actuating handle of claim 19, wherein the handle is configured to be axially linked to the transmission element.

22. The actuating handle of claim 1, further comprising a bearing arranged and configured between the handle and the stop element.

23. The actuating handle of claim 22, wherein the bearing is a sliding bearing.

24. The actuating handle of claim 22, wherein the bearing is a roller bearing assembly.

25. The actuating handle of claim 1, wherein the handle is arranged and configured to operate against a restoring force.

26. The actuating handle of claim 25, further comprising a reversing device arranged and configured to provide the restoring force to the handle.

27. The actuating handle of claim 26, wherein the reversing device is coupled to the handle and irrotationally coupled to the stop element.

28. The actuating handle of claim 26, further comprising at least one receiving element, the receiving element being configured to interact with the reversing device.

29. The actuating handle of claim 28, wherein the receiving element defines a recess configured to house the reversing device.

30. The actuating handle of claim 28, wherein the receiving element is arranged and configured on the rear surface of the stop element.

31. The actuating handle of claim 28, wherein the stop element defines a larger cross section than the cross section of the receiving element.

32. The actuating handle of claim 28, wherein the receiving element is irrotationally coupled to the stop element.

33. The actuating handle of claim 28, wherein the receiving element and the stop element are a single unitary piece.

34. The actuating handle of claim 1, further comprising a locking device arranged and configured to selectively block the rotation of the handle relative to the stop element.

35. The actuating handle of claim 34, wherein the locking device includes at least one inhibitor configured to selectively stop the handle.

36. The actuating handle of claim 34, further comprising at least one lever arranged and configured for selective actuation of the inhibitor.

37. The actuating handle of claim 36, wherein the lever is supported one of in and on the stop element, and wherein the lever is selectively rotatively displaceable relative to the stop element.

38. The actuating handle of claim 34, wherein at least a portion of the locking device is arranged and configured within the receiving element.

39. The actuating handle of claim 36, wherein the receiving element defines an additional recess arranged and configured to house the locking device.

40. The actuating handle of claim 34, wherein the locking device is mirror-symmetrical in a direction perpendicular to the longitudinal axis.

41. A door with a door leaf and at least one actuating handle, the actuating handle comprising:
at least two stop elements configured to be attachable to the door by at least one mounting member; and
a handle configured to operate at least one of the door and a lock inserted into the door;
wherein the mounting member is linked to a stop element such that it is arranged and configured to be inserted into the lock through a side surface of the door; and
wherein the mounting member is arranged and configured to be affixed one of on and in the lock perpendicular to a longitudinal axis of the stop elements.

42. The door of claim 41, further comprising one actuating handle on each side surface of the door.

43. The door of claim 42, wherein the handles are arranged and configured opposite each other and in line with the longitudinal axis of the stop elements.

44. The door of claim 41, wherein the lock is incorporated into the face of the door leaf of the door.

45. The door of claim 41, wherein the lock is a mortise lock, configured to be affixed to door leaf by an astragal.

46. The door of claim 41, wherein the lock includes a selectively rotatable lock socket configured to operate a latch.

47. The door of claim 41, wherein the lock includes at least one of a through hole, a through bore, and a through sleeve configured to house at least two mounting members.

48. The door of claim 47, including at least two through holes symmetrically located around the lock socket.

49. The door of claim 41 wherein the lock includes at least one additional through hole.

50. The door of claim 49, wherein the additional through hole is one of a through bore, a through sleeve and an additional lock socket.

51. The door of claim 48, wherein at least one mounting member of opposing stop elements extends into one of the through holes of the lock when the actuating handles are mounted.

52. The door of claim 47, wherein the first stop element includes at least one pin;
wherein the second stop element includes at least one sleeve;
wherein the at least one pin is configured to extend into the at least one sleeve creating an interference fit; and
wherein at least one of the at least one pin and the at least one sleeve extend through a through hole defined by the lock.

53. The door of claim 47, wherein a first stop element on a first side surface of the door and a matching segment of a second stop element on a second side surface of the door jointly form one of a stud and a sleeve-like element that extends through a through hole of the lock when the actuating handles are installed.

54. The door of claim 41, wherein at least one recess is defined in each side surface of the door.

55. The door of claim 54, further comprising matching opposite recesses arrayed substantially concentrically to each other in the direction of the longitudinal axis.

56. The door of claim 54, wherein at least one first recess is arranged and configured such that a lock socket of the lock is freely accessible the side surfaces of the door leaf.

57. The door of claim 54, wherein at least one additional recess is defined such that at least one through hole of the lock is freely accessible through the side surfaces of the door leaf.

58. The door of claim 54, wherein at least one additional recess is defined such that at least one additional through hole of the lock is freely accessible through the side surfaces of the door leaf.

59. The door of claim 54, wherein the stop element defines a cross section such that the recesses are covered completely by the stop element.

60. The door of claim 54, wherein the first recess is defined such that at least one of a lock socket, through holes and the additional through holes of the lock are freely accessible through the door leaf.

61. The door of claim 60, wherein the stop element defines a cross section greater than the cross section defined by the first recess.

62. The door of claim 60, wherein at least one stop element defines a step-like edge, and wherein the stop element is supported on the edge of the first recess by the step-like edge.

63. The door of claim 60, wherein the receiving element is sized to be received in the first recess.

64. The door of claim 60, wherein the stop element is sized to be received in the recess.

65. The door of claim 64, wherein the stop element is arranged and configured flush with the side surface of one of the door and of the door leaf.

66. The door of claim 64, wherein the receiving element is sized to be received in the recess.

67. The door of claim 66, wherein the additional recesses in the side surfaces of the door have identical internal diameters as the associated through holes in the lock.

68. The door of claim 67, wherein the additional recesses in the side surfaces of the door and the lock within the door leaf arranged and configured relative to each other such that the additional recesses and the through holes are substantially concentric.

69. The door of claim 67, wherein at least one mounting member of the opposite stop elements extends perpendicular to the longitudinal axis into one of the additional recesses of the door and into one of the through holes in the lock when the actuating handles are mounted.

70. The door of claim 41, wherein the transmission element axially fixes the opposing actuating handles.

71. (canceled)

72. The door of claim 41, further comprising a device between at least one handle and the transmission element arranged and configured such that the transmission element may be inserted into the handle in a first direction, but that it is blocked in the opposite direction.

73. An actuating handle set for a door, the door including a lock, the door further defining a bore extending through the door, with the bore exposing a portion of the lock, the actuating handle set comprising:
a pair of stop elements, each stop element defining a central recess and including at least one mounting member, the at least one mounting member of one stop element being configured to engage and couple with the mounting member of the other stop element without tools;
a pair of handles, with one handle positioned on one side of the door and the other handle positioned on another side of the door; and
a transmission element extending through the bore and operatively coupled to the lock;
wherein each of the handles is configured to engage and securely couple with an end of the transmission element; and
wherein the transmission element extends through the central recess of each stop.

74. The actuating handle of claim 73, further comprising an integrated locking device including an inhibitor arranged and configured to selectively rotationally fix the transmission element and the handles.

75. The actuating handle of claim 74, wherein the inhibitor is coupled to a lock shaft disposed in the bore substantially parallel to the transmission element.

76. The actuating handle of claim 75, wherein the integrated locking device is disposed in a receiving element, the receiving element including a pair of corresponding housing members, each housing member defining a recess corresponding to the central recess and configured to receive the transmission element, and each housing member further defining a locking shaft bore configured to receive the locking shaft.

77. The actuating handle set of claim 74, further comprising a lever configured to selectively actuate the integrated locking device.

78. The actuating handle set of claim 73, further comprising a reversing device in operative communication with the transmission element and arranged and configured to provide a rotationally restoring force to the transmission element and the handles.

79. The actuating handle set of claim 73, wherein each mounting member is one of a pin and a sleeve, the sleeve configured to engage the pin and form an interference fit therewith.

80. The actuating handle set of claim 73, wherein the stop elements include a front surface distal from the lock and a rear surface proximate the lock; and
wherein the mounting members are coupled to the rear surface and extend outwardly therefrom towards the lock.

81. The actuating handle set of claim 80, wherein the mounting members are not accessible from the front surface of the stop elements.

82. The actuating handle set of claim 80, wherein each mounting member is irrotationally coupled to the corresponding stop element.

83. The actuating handle set of claim 73, further comprising a bearing associated with each handle, arranged and configured to allow rotation of each handle.

84. The actuating handle set of claim 73, further comprising additional sleeves configured to be coupled to the mounting members, thereby extending the mounting members.

85. The actuating handle set of claim 73, further comprising a device between at least one handle and the transmission element arranged and configured such that the transmission element may be inserted into the handle in a first direction, but that it is blocked in the opposite direction.
